(19) United States
(12) Patent Application Publication
(10) Pub. No.: US 2026/0241688 A1
(43) Pub. Date: Aug. 20, 2026

(54) INKJET HEAD AND INKJET RECORDING DEVICE

(71) Applicant: Konica Minolta, Inc., Tokyo (JP)

(72) Inventors: Yoshiro TODA, Tokyo (JP); Hideo WATANABE, Tokyo (JP); Katsutoshi SAWADA, Tokyo (JP)

(21) Appl. No.: 19/164,355

(22) PCT Filed: Mar. 4, 2024
(86) PCT No.: PCT/JP2024/008045

§ 371 Date: Sep. 11, 2025

(30) Foreign Application Priority Data
Mar. 14, 2023 (JP) 2023-039518

(51) Int. Cl. B41J 2/14

(52) U.S. Cl. CPC B41J 2/14209; B41J 2002/14419; B41J 2202/10; B41J 2202/11; B41J 2202/12

(57) ABSTRACT

This inkjet head comprises a plurality of individual supply channels that individually supply ink from a common supply channel to a plurality of nozzle parts, and a plurality of individual circulation channels that individually discharge the ink from the plurality of nozzle parts to the common circulation channel, the individual pressure loss resistance of the plurality of individual circulation channels, for which the overall pressure loss resistance is greater than that of the plurality of individual supply channels, being made uniform, and the individual pressure loss resistance of the plurality of individual supply channels being made nonuniform so that the pressure of the plurality of nozzle parts is made uniform.

### TECHNICAL FIELD

The present invention relates to an inkjet head and an inkjet recording apparatus.

### BACKGROUND ART

An inkjet recording apparatus has been known that performs drawing on a recording medium by ejecting (also referred to as “jetting”) ink from nozzles of a nozzle section and landing the ink on the recording medium while relatively moving an inkjet head including a plurality of nozzle sections and the recording medium such as a sheet. An inkjet recording apparatus generally includes a plurality of nozzle sections capable of storing ink therein and a supply channel for supplying the ink to the plurality of nozzle sections and causes the ink in the nozzle sections to be ejected from the nozzles by varying the pressure in the nozzle sections. Furthermore, to adjust the amount of ink to be supplied, the inkjet recording apparatus may be provided with a circulation channel (also referred to as a discharge channel) for collecting part of the ink to be supplied to the nozzle section and supplying it again.

For example, in the inkjet recording apparatus described in PTL 1, ink flows in mutually opposite directions in a common supply channel and a common circulation channel which respectively communicate with a plurality of nozzle sections arranged in a longitudinal direction and are parallel to each other. This makes the pressure loss resistance on the supply side and the pressure loss resistance on the circulation side equal to each other at the positions of the respective nozzle sections, whereby the pressure distributions of both sides are offset, and the nozzle pressures of all the nozzle sections are made uniform.

In addition, for example, in the inkjet recording apparatus described in PTL 2, the pressure loss in the plurality of individual supply channels connecting the common supply channel and the corresponding nozzle sections is made non-uniform by varying the length or the like between the individual supply channels, and the pressure loss in the plurality of individual circulation channels connecting the common supply channel and the corresponding nozzle sections is also made non-uniform by varying the length or the like between the individual circulation channels. Thus, the pressures of all the nozzle sections are made uniform.

### CITATION LIST

### Patent Literature

### PTL 1

Japanese Patent Application Laid-Open No. 2012-61768

### PTL 2

Japanese Patent Application Laid-Open No. 2015-131475

### PTL 3

WO2018/08397

### SUMMARY OF INVENTION

### Technical Problem

Incidentally, there is a case where a configuration is adopted in which pressure loss of the individual circulation channel is made greater than a pressure loss of the individual supply channel so that the pressure generated in the nozzle section does not escape to the channel on the discharging side or does not propagate to another nozzle section. As an example of such a configuration, there is a configuration in which the cross-sectional area or the like of the individual circulation channel is made relatively small and the cross-sectional area or the like of the individual supply channel is made relatively large. This is based on the fact that the pressure loss of the fluid flowing through the pipeline increases as the cross-sectional area of the pipeline decreases.

In this regard, for example, an inkjet recording apparatus described in PTL 1 adopts a configuration in which ink flows in opposite directions in a common supply channel and a common circulation channel so that pressure loss resistances on the supply side and the discharge side are made equal, but since the pressure loss on the discharge side cannot be made greater than the pressure loss on the supply side with this configuration, there is a problem that escape of pressure generated in the nozzle section as described above to the circulation channel and propagation of the pressure to other nozzle sections cannot be suppressed.

Furthermore, for example, an inkjet recording apparatus described in PTL 2 adopts a configuration in which pressure loss in individual channels are made different between a supply side and a discharge side. However, with the configuration in which the cross-sectional area or the like of the individual circulation channel is made relatively small as described above, the individual circulation channel is minute. Therefore, it is practically difficult to form the individual circulation channels in mutually different shapes or the like so as to obtain a desired pressure loss distribution, in consideration of manufacturing costs and manufacturing variations. Therefore, there is a risk that the escape of the pressure generated in the nozzle section to the circulation channel or propagation of the pressure to another nozzle section cannot be suppressed.

Furthermore, the pressure loss of the fluid flowing through the pipeline increases in proportion to the viscosity of the fluid. Therefore, in a case where high-viscosity ink is used in a conventional inkjet recording apparatus, a pressure difference between an upstream side (inlet side) and a downstream side of the common supply channel becomes extremely large, and the pressure difference remains as it is as a pressure difference between nozzle sections (pressure distribution between nozzle sections). If a pressure distribution occurs among the nozzle sections during non-ejection, the pressures of all the nozzle sections may not be set within a desired range when the nozzle sections are driven at ejecting. As a result, ejection failure such as ink overflow or air bubble entrainment in the nozzle section may be caused.

In general, conventional inkjet recording apparatus have a certain limit in improving the ejection stability of the nozzle section.

An object of the present invention is to provide an inkjet head and an inkjet recording apparatus that can more reliably secure ejection stability of a nozzle section.

### Solution to Problem

One aspect of an inkjet head according to the present invention includes: a plurality of individual supply channels that individually supply ink from a common supply channel to a plurality of nozzles; and a plurality of individual circulation channels that individually discharge the ink from the plurality of nozzles to a common circulation channel, in which pressure loss resistances of the plurality of individual circulation channels having greater overall pressure loss resistance than the plurality of individual supply channels are made uniform, and pressure loss resistances of the plurality of individual supply channels are made non-uniform so that pressures of the plurality of nozzles are made uniform.

One aspect of an inkjet recording apparatus according to the present invention includes a drawer that includes the inkjet head described above, supplies ink to the plurality of nozzles through the common supply channel and the plurality of individual supply channels while circulating the ink through the plurality of individual circulation channels and the common circulation channel, and ejects the ink from the plurality of nozzles to perform drawing.

### Advantageous Effects of Invention

According to the present invention, it is possible to more reliably secure the ejection stability of the nozzle section.

### BRIEF DESCRIPTION OF DRAWINGS

FIG. 1 is a diagram illustrating a schematic configuration of an inkjet printer including an inkjet head according to an embodiment;

FIG. 2 is a block diagram illustrating a main part of a control system of the inkjet printer;

FIG. 3 is a diagram schematically illustrating an arrangement configuration of the inkjet heads in a head unit of the inkjet printer;

FIG. 4 is a perspective view of an appearance of the inkjet head;

FIG. 5A is a diagram schematically illustrating a configuration of a main part of a cross section along a lateral direction of a head chip in the inkjet head;

FIG. 5B is a diagram schematically illustrating the configuration of the main part of the cross section along a longitudinal direction of the head chip in the inkjet head;

FIG. 6 is a diagram schematically illustrating a planar configuration around nozzles in the inkjet head;

FIG. 7 is a diagram schematically illustrating a configuration of a main part of a cross section along a longitudinal direction of a head chip in an inkjet head according to Variation 1 of the embodiment;

FIG. 8 is a diagram schematically illustrating a configuration of a main part of a cross section along a longitudinal direction of a head chip in an inkjet head according to Variation 2 of the embodiment;

FIG. 9 is a diagram schematically illustrating a configuration of a main part of a cross section along a longitudinal direction of a head chip in an inkjet head according to Variation 3 of the embodiment; and

FIG. 10 is a diagram schematically illustrating a planar configuration around nozzles in an inkjet head according to Variation 4 of the embodiment.

### DESCRIPTION OF EMBODIMENTS

Hereinafter, an embodiment of the present invention will be described with reference to the drawings.

### [Inkjet Printer 1]

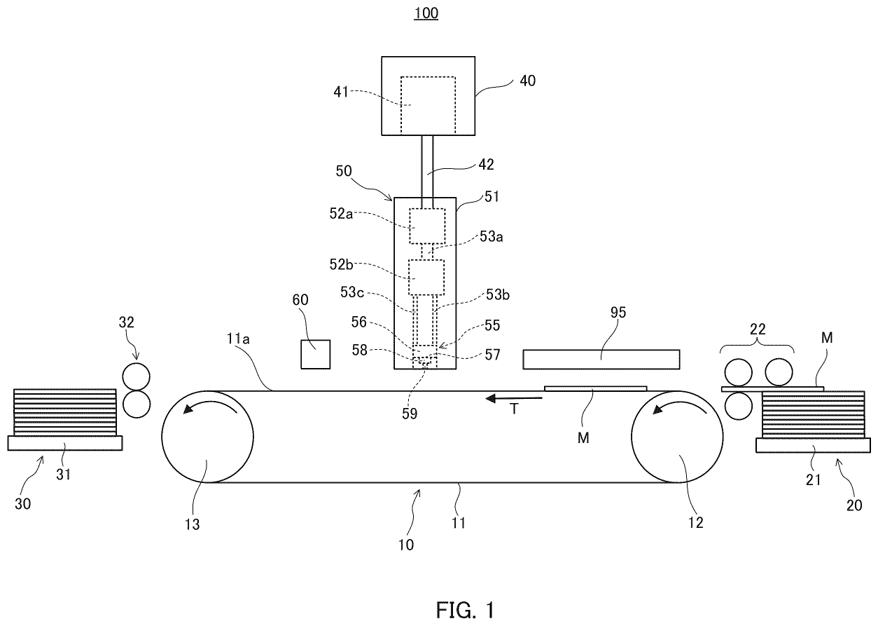

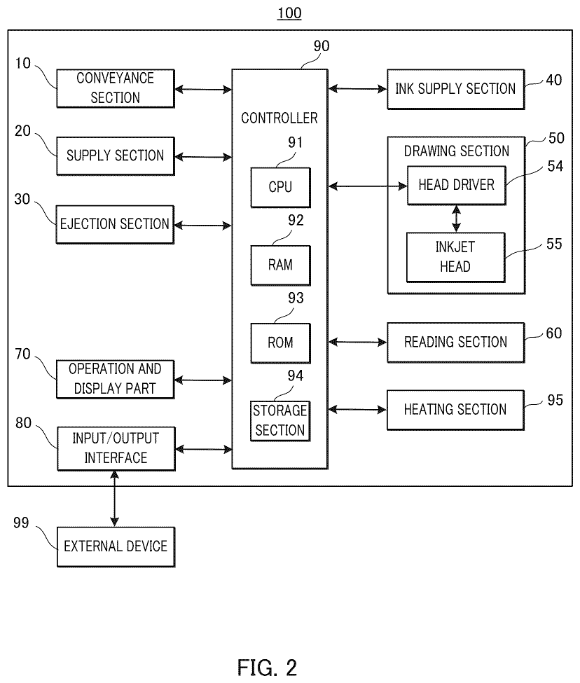

FIG. 1 is a diagram illustrating a schematic configuration of an inkjet printer including an inkjet head according to the present embodiment, and FIG. 2 is a block diagram illustrating a main part of a control system of the inkjet printer. The inkjet printer described below is an example of an inkjet recording apparatus.

As illustrated in FIG. 1 and FIG. 2, the inkjet printer 1 includes a conveyance section 10, a supply section 20, an ejection section 30, an ink supply section 40, a drawing section (i.e., drawer) 50, a reading section 60, an operation and display part 70, an input/output interface 80, and a controller 90.

The conveyance section 10 includes a plurality of members related to conveyance, such as a conveyance belt 11, a drive roller 12, and a driven roller 13. The conveyance section 10 conveys the recording medium M through the conveyance operation of the plurality of members such as a conveyance belt 11. Specifically, in the conveyance section 10, the conveyance belt 11 is stretched around a drive roller 12 and a driven roller 13 and is driven by rotationally driving the drive roller 12. Accordingly, the recording medium M supplied from the supply section 20 are conveyed to the drawing section 50 in a state of being placed on the conveyance surface 11a of the conveyance belt 11 and are conveyed to the ejection section 30 after being subjected to drawing (also referred to as image formation or printing) in the drawing section 50.

As the recording medium M, various media on which the ink ejected from the inkjet head 55 can be fixed can be used. The recording medium M is, for example, a medium such as a sheet-like paper, textile (fabric), or resin. The recording medium M is not limited to a sheet-like medium and may be a medium such as a roll-shaped paper, cloth, or resin. As an example of the recording medium M made of resin, a substrate such as a printed circuit board (PCB) is exemplified. In the case of the substrate such as a Printed Circuit Board (PCB), the drawing by the inkjet printer 1 can be applied to the printing of the solder resist or the marking ink on the PCB substrate. In addition, examples of the recording medium M which can be a drawing target include a metal body of an automobile, a building material (an outer wall, a roof material, a tile, or the like), and a can (a metal can for packing food, beverage, or the like). In the case of various building materials and various metal products, the drawing by the inkjet printer 1 can be applied to the coating of the various building materials and the various metal products.

Here, as an example, the conveyance section 10 that conveys the recording medium M by the conveyance belt 11 is exemplified. However, the conveyance section 10 is not limited thereto, and may be configured to convey the recording medium M by a drum or a roller instead of the conveyance belt 11.

The supply section 20 includes a supply stacking section 21 that stacks and stores a plurality of recording media M, and a supply conveyance section 22 that conveys and supplies the recording media M from the supply stacking section 21 to the conveyance section 10. The supply stacking section 21 is configured to be movable up and down, and when the topmost recording medium M is conveyed to the conveyance section 10 by the supply conveyance section 22, the supply stacking section 21 moves up so that the topmost recording medium M can be conveyed to the supply conveyance section 22 after the conveyance.

The ejection section 30 includes an ejection stacking section 31 that stacks and stores a plurality of recording media M, an ejection conveyance section 32 that conveys the recording media M ejected from the conveyance section 10 to the ejection stacking section 31, and the like. The ejection stacking section 31 is configured to be movable up and down, and when the recording medium M is conveyed from the ejection conveyance section 32 to the ejection stacking section 31, the ejection stacking section 31 moves down.

The supply conveyance section 22 and the ejection conveyance section 32 each include, for example, a plurality of rollers, and rotate the rollers to convey the recording medium M. The supply conveyance section 22 and the ejection conveyance section 32 are not limited to rollers, and may each be constituted by a belt, or may each be constituted by a combination of a roller and a belt.

In a case where a roll-shaped medium is used as the recording medium M, an unwinding roller on which the roll-shaped medium is stored in a wound state or a winding roller that winds the roll-shaped medium is used instead of the supply stacking section 21 or the ejection stacking section 31. The roll-shaped medium is conveyed to the conveyance section 10 by rotating the unwinding roller and is wound up around the winding roller by rotating the winding roller.

In addition, a post-processing device that performs post-processing on the recording medium M on which an image is formed by the drawing section 50 may be provided between the conveyance section 10 and the ejection section 30. Examples of the post-processing device include a fixing device that fixes ink to the recording medium M. For example, in a case where an ultraviolet curable ink is used as the ink, a fixing device that fixes the ink to the recording medium M by irradiating the recording medium M with ultraviolet rays is used. In addition, for example, in a case where a water-based ink or a solvent ink is used as the ink, a fixing device that fixes the ink to the recording medium M by a method such as drying is used. Further, as the post-processing device, a device other than the fixing device, for example, a cutting device that cuts the recording medium M into a desired length may be used.

The configurations of the conveyance section 10, the supply section 20, and the ejection section 30 can be variously changed and implemented according to the type of the recording medium M which is a drawing target.

The ink supply section 40 is a device which supplies ink to a first sub-tank 52a of the drawing section 50 which will be described later. The ink supply section 40 includes a main tank 41 and unillustrated members (e.g., a pump and a valve) related to the supply of ink. The main tank 41 stores ink to be supplied to the first sub-tank 52a at room temperature. The ink supply section 40 supplies ink from the main tank 41 to the first sub-tank 52a via a channel 42, by using a pump or the like (not illustrated).

In the present embodiment, gel ink (phase-transition ink) containing wax that acts as a gel component undergoing a reversible sol-gel phase transition in response to temperature change, is used as the ink. For example, it is possible to use energy ray curable gel ink (as an example, ultraviolet curable gel ink or the like) which is in a gel state at room temperature, is in a sol state at a temperature equal to or higher than the heated phase-transition temperature, and is cured by being irradiated with an energy ray.

The heating section 95 is disposed on the upstream side of the drawing section 50 in the conveyance direction T of the recording medium M and heats the recording medium M conveyed by the conveyance belt 11 to a predetermined temperature. The heating section 95 is connected to the controller 90 (see FIG. 2) and is controlled by the controller 90.

For example, the heating section 95 includes an infrared rays heater or the like and heats the recording medium M to a predetermined temperature by causing the infrared rays heater to generate heat when electric power is supplied to the infrared rays heater based on a control signal supplied from the controller 90. In the present variation, the predetermined temperature is equal to or higher than the phase-transition temperature of the gel component of the gel ink. Depending on the type of ink to be used, the heating section 95 may not be provided. Note that in the following description, “gel ink” is simply referred to as “ink.”

Here, the heating section 95 is disposed on the upper surface side of the conveyance belt 11, but a heating section may be provided on the lower surface side of the conveyance belt 11 instead of (or in addition to) the heating section 95, and the recording medium M may be heated by heating the conveyance belt 11.

The drawing section 50 includes a carriage 51, a first sub-tank 52a, a second sub-tank 52b, channels 53a, 53b, and 53c, a head driver 54, an inkjet head (hereinafter, simply referred to as a head) 55, and the like (see FIG. 1 and FIG. 2).

Note that although the ink supply section 40 and the drawing section 50 for one color are illustrated in FIG. 1 for simplicity of illustration, the ink supply section 40 and the drawing section 50 corresponding to the number of colors to be used are arranged. For example, when four colors of yellow (Y), magenta (M), cyan (C), and black (K) are used, the ink supply sections 40 and the drawing sections 50 for the four colors are arranged, and the drawing sections 50 are disposed so as to be arranged at predetermined intervals along the conveyance direction T.

Although a plurality of the second sub-tanks 52b and a plurality of the heads 55 are connected to the downstream of the first sub-tank 52a, one of each is illustrated in FIG. 1 in order to simplify the illustration.

The carriage 51 is a housing that internally holds the first sub-tank 52a, the second sub-tank 52b, the channels 53a, 53b, and 53c, the head driver 54, the head 55, and devices and members necessary for image formation. Furthermore, although not illustrated, the carriage 51 includes an ink heating section that heats the ink in the carriage 51 to a temperature equal to or higher than a phase-transition temperature of the gel component of the ink and maintains the temperature.

The first sub-tank 52a is connected to the downstream of the main tank 41. The first sub-tank 52a stores the ink supplied from the main tank 41 in the carriage 51. The ink in the sub-tank 52 is supplied to the second sub-tank 52b via the channel 53a by using a pump or the like (not illustrated) in the carriage 51.

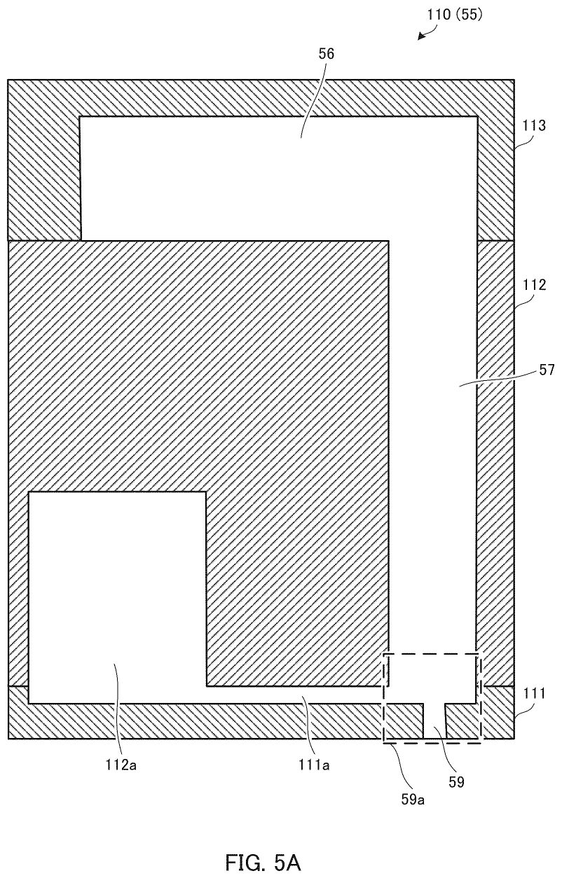

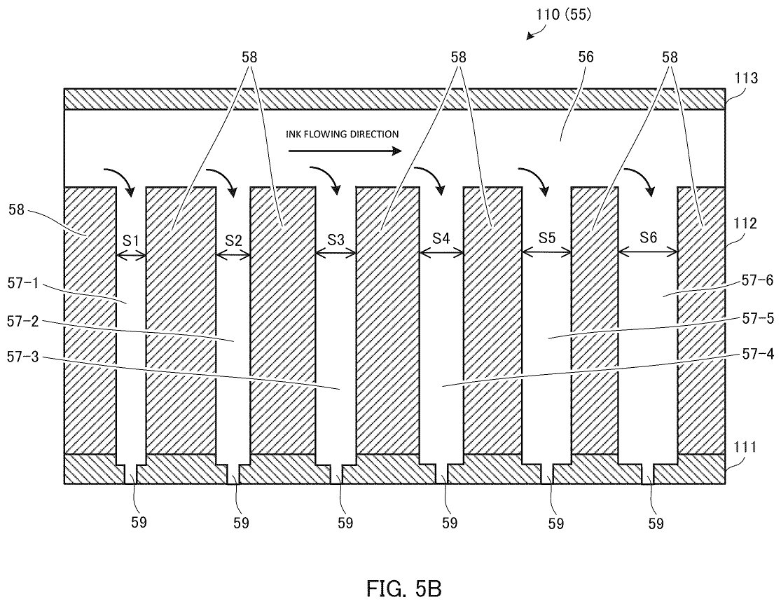

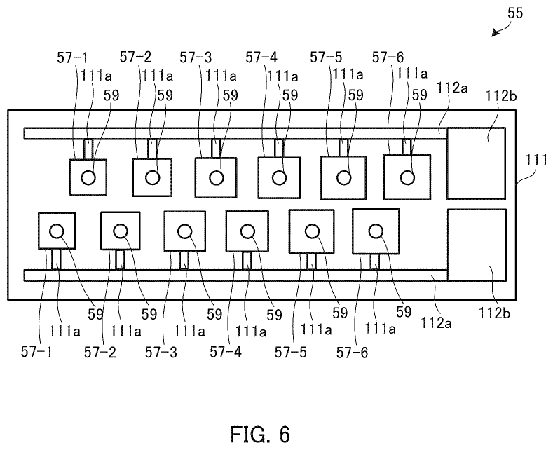

The plurality of second sub-tanks 52b is connected to a downstream of the first sub-tank 52a. The second sub-tanks 52b store the ink supplied from the first sub-tank 52a in the carriage 51. The ink in the second sub-tanks 52b is supplied to a manifold 56 of the head 55, which will be described later, via the channel 53b by using a pump or the like (not illustrated) in the carriage 51. Also, part of ink supplied to the manifold 56 is returned (collected) to the second sub-tanks 52b via the channel 53c, so that ink can be resupplied to the manifold 56. That is, the ink is circulated between the second sub-tanks 52b and the manifold 56 via the channels 53b and 53c. This circulation channel also includes a plurality of individual circulation channels 111a, a common circulation channel 112b, and a vertical circulation channel 112c (see FIGS. 5A, FIG. 5B, and FIG. 6), all of which will be described later.

The head driver 54 outputs a drive voltage corresponding to image data of an image to be formed to a piezoelectric element 58 of the head 55 to be described later on the basis of control of the controller 90 to be described later. The piezoelectric element 58 is driven by the drive voltage from the head driver 54 and causes ink to be ejected in an amount corresponding to image data from nozzles 59 of the head 55 which will be described later.

The plurality of heads 55 are respectively connected to the downstream sides of the plurality of second sub-tanks 52b. That is, a plurality of second sub-tanks 52b and a plurality of heads 55 are connected to the first sub-tank 52a on the downstream side.

The head 55 includes a manifold 56 (an example of a common supply channel), an individual supply channel 57, a piezoelectric element 58, a nozzle 59, an individual circulation channel 111a, a common circulation channel 112b, and a vertical circulation channel 112c (refer to FIGS. 5A, FIG. 5B, and FIG. 6). The head 55 includes a plurality of nozzles 59, and individual supply channels 57 and piezoelectric elements 58 are provided in accordance with the number of nozzles 59. Note that in the present embodiment, the nozzle section 59a is a portion including the nozzle 59 and a space capable of temporarily storing ink in the vicinity of the nozzle 59 (see FIG. 5A).

The manifold 56 communicates with a plurality of individual supply channels 57, and the ink supplied to the manifold 56 is supplied to the individual supply channels 57. Some or all of the individual supply channels 57 are chambers each having an internal space in which ink to be ejected from the nozzle 59 can be temporarily stored. A piezoelectric element 58 is provided on a wall surface of the individual supply channel 57. In addition, one end of the nozzle 59 communicates with the individual supply channel 57, and the other end is an opening end.

A drive voltage from the head driver 54 is applied to the piezoelectric element 58. When the drive voltage from the head driver 54 is applied to the piezoelectric element 58, the piezoelectric element 58 is deformed according to the applied drive voltage, the individual supply channel 57 is deformed, and a pressure change is applied to the ink in the individual supply channel 57 to be supplied to the nozzle 59 by the deformation of the individual supply channel 57.

Therefore, when a drive voltage from the head driver 54 is applied to the piezoelectric element 58, the piezoelectric element 58 and the individual supply channel 57 are deformed to apply a pressure change to the ink in the individual supply channel 57, and as a result, the ink in the individual supply channel 57 is ejected from the nozzle 59. In this way, an image can be formed on the recording medium M by ejecting ink from the nozzle 59.

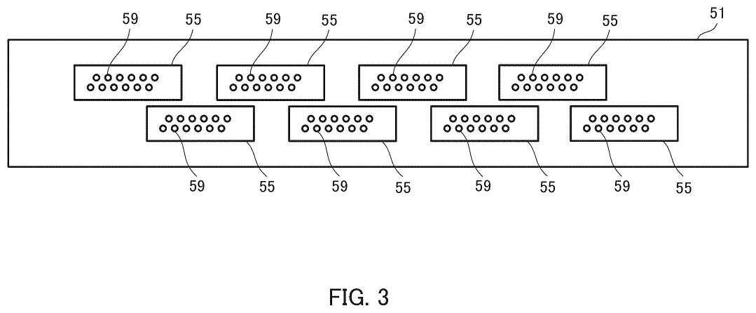

In the carriage 51, the head 55 may be configured to operate in a single-pass (one pass) manner in which image formation is performed by one scan or may be configured to operate in a scanning (multi-pass) manner in which image formation is performed by a plurality of scans. In the case of the single-pass method, in the carriage 51, a number of heads 55 corresponding to the image formation width are arranged in the width direction of the recording medium M (the direction orthogonal to the conveyance direction T of the recording medium M) (see FIG. 3). As illustrated in FIG. 3, the plurality of heads 55 are arranged in one row or a plurality of rows with their longitudinal direction along the width direction of the recording medium M, and in each head 55, a plurality of nozzles 59 are arranged linearly or in a lattice pattern along the longitudinal direction of the head 55.

The reading section 60 is located downstream of the drawing section 50 in the conveyance direction T of the recording medium M and reads an image (e.g., a predetermined pattern image) formed on the recording medium M conveyed by the conveyance belt 11. The reading section 60 outputs a reading result of the predetermined pattern image to the controller 90. The controller 90 changes an image forming condition, for example, a position where the image is formed, a driving condition of the head 55, or the like based on the reading result.

In addition, although not shown, the inkjet printer 1 includes a maintenance section that performs maintenance such as cleaning of the head 55.

The operation and display part 70 is, for example, a flat panel display such as a liquid crystal display or an organic electro luminescence (EL) display with a touch screen. The operation and display part 70 displays an operation menu for a user, information on image data, various states of the inkjet printer 1, and the like. The operation and display part 70 also includes a plurality of keys and receives various input operations from the user.

The input/output interface 80 mediates transmission and reception of data between the external device 99 and the controller 90. The input/output interface 80 includes, for example, various serial interfaces, various parallel interfaces, or a combination of these interfaces.

The external device 99 is, for example, a computer or a facsimile machine and sends print jobs, image data, and the like to the controller 90 via the input/output interface 80.

The controller 90 includes a central processing unit (CPU) 91, a random access memory (RAM) 92, a read only memory (ROM) 93, and a storage section 94.

The CPU 91 reads various control programs and data items stored in the ROM 93, stores the read programs and data in the RAM 92, and executes the program to conduct various calculation processes. For example, the controller 90 generates a drive signal for an image to be formed based on image data received from the input/output interface 80, and outputs the drive signal to the head 55.

The RAM 92 provides a working memory space for the CPU 91 and stores temporary data. Note that the RAM 92 may include a nonvolatile memory.

The ROM 93 stores various control programs, setting date, and the like executed by the CPU 91. Note that a rewritable nonvolatile memory such as an electrically erasable programmable read only memory (EEPROM) or a flash memory may be used instead of the ROM 93.

The storage section 94 stores print jobs and image data associated with the jobs input from an external device 99 via the input/output interface 80. As the storage section 94, for example, a nonvolatile semiconductor memory (so-called flash memory) or a hard disk drive (HDD) is used, and a dynamic random access memory (DRAM) or the like may be used in combination.

The conveyance section 10, the supply section 20, the ejection section 30, the ink supply section 40, the drawing section 50, the reading section 60, the operation and display part 70, the input/output interface 80, the heating section 95, and the like are each connected to the controller 90. The controller 90 comprehensively controls the entire operation of the inkjet printer 1. The conveyance section 10, the supply section 20, the ejection section 30, the ink supply section 40, the drawing section 50, the reading section 60, the operation and display part 70, the input/output interface 80, the heating section 95, and the like are controlled by the controller 90 to execute predetermined processing.

Under the control of the controller 90, the inkjet printer 1 having the above-described configuration feeds the recording medium M from the supply section 20 to the conveyance section 10, causes the drawing section 50 to form an image on the recording medium M conveyed by the conveyance section 10, and conveys the recording medium M having the image formed thereon to the ejection section 30.

### [Head (Inkjet Head) 55]

Subsequently, the configuration of an inkjet head (head 55) according to the present embodiment is described. The configuration described here is a configuration of the head 55 alone. Note that all the heads 55 in the inkjet printer 1 may have the same configuration, or the inkjet printer 1 may include a head 55 having a configuration different from the configuration described below.

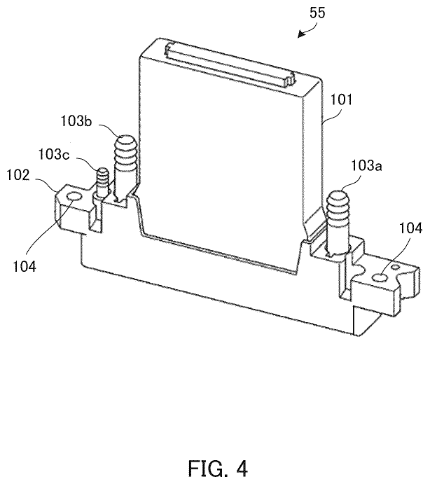

FIG. 4 is a perspective view of an appearance of the head 55.

The head 55 includes a housing 101 and an exterior member 102 that is fitted to the housing 101 at a lower end of the housing 101, and main components are housed inside the housing 101 and the exterior member 102. The exterior member 102 is provided with an inlet 103a through which ink is supplied from the outside, and outlets 103b and 103c through which ink is discharged to the outside. A manifold 56 connected to the inlet 103a is provided inside the exterior member 102. In addition, a plurality of attachment holes 104 for attaching the inkjet head 100 to the base section of the carriage 51 are provided in the exterior member 102.

FIG. 5A and FIG. 5B are diagrams illustrating a configuration of a main part of a head chip in the head 55. FIG. 5A is a diagram schematically illustrating a configuration of a main part of a cross section along a lateral direction of a head chip, and FIG. 5B is a diagram schematically illustrating a configuration of a main part of a cross section along a longitudinal direction of a head chip. FIG. 6 is a diagram schematically illustrating a planar configuration around nozzles in the head 55.

The components housed inside the housing 101 and the exterior member 102 of the head 55 includes a head chip 110. As shown in FIG. 5A and FIG. 5B, the head chip 110 is configured by laminating a plurality of substrates (a first substrate 111, a second substrate 112, and a third substrate 113) and adhering these substrates. The first substrate 111, the second substrate 112, and the third substrate 113 serves as a lower layer, an intermediate layer, and an upper layer, respectively, when in use.

The first substrate 111 is provided with a plurality of nozzles 59, which are each a hole penetrating in a thickness direction (corresponding to the ink ejection direction, which is typically a direction along the vertical direction). The plurality of nozzles is provided so as to form rows along the longitudinal direction. In the illustrated example, the number of nozzles 59 is six per raw, but the number may not be six. The first substrate 111 may be, for example, a substrate made of resin such as polyimide or may be a substrate made of metal such as SUS.

A liquid repellent film containing a liquid repellent substance, such as fluorine resin particles, is provided on the nozzle opening surface of the first substrate 111. By providing the liquid repellent film, it is possible to suppress the adhesion of ink or foreign substance to the nozzle opening surface, and it is possible to suppress the occurrence of ink ejection failures due to the adhesion of ink, foreign substance, or the like.

The first substrate 111 is also provided with a plurality of individual circulation channels 111a which respectively communicate with the plurality of nozzles 59. The plurality of individual circulation channels 111a are grooves extending in parallel to each other in the lateral direction of the head 55 from the most downstream portions of the individual supply channels 57 communicating with the corresponding nozzles 59, and all of them communicate with the common circulation channel 112a.

In the second substrate 112, a plurality of individual supply channels 57 which are holes respectively penetrating in the thickness direction and respectively communicate with the corresponding nozzles 59 are provided so as to form rows along the longitudinal direction. In the illustrated example, since the number of nozzles 59 is six per row, the number of individual supply channels 57 is also six per row. Note that in the following description, the six individual supply channels 57 are referred to as individual supply channels 57-1, 57-2, 57-3, 57-4, 57-5, and 57-6 when they are described so as to be distinguished from each other and are simply referred to as “individual supply channels 57” when they are not distinguished from each other. The relative positions of the individual supply channels 57-1, 57-2, 57-3, 57-4, 57-5, and 57-6 are positions farther away from the inlet (inlet 103a) of the manifold 56, that is, positions on the downstream side of the manifold 56, as the branch number of the reference numeral is larger.

Each of the plurality of individual supply channels 57 communicates with the manifold 56, which functions as a common supply channel, at its most upstream portion. The plurality of individual supply channels 57 are partitioned by a partition wall including the piezoelectric element 58. The piezoelectric element 58 is electrically connected to the head driver 54 by electrodes and wiring (not illustrated). The piezoelectric element 58 is driven in response to a drive voltage signal applied from the head driver 54 via the electrode and the wiring to repeatedly cause shear-mode type displacement in the partition walls of the individual supply channels 57, thereby changing the pressure of the ink and ejecting the ink from the nozzle 59 in response to the pressure change. That is, the head 55 according to the present embodiment is an inkjet head that performs shear mode type ink ejection.

The second substrate 112 is made of, for example, a ceramic piezoelectric material (a member that deforms in response to voltage application). Examples of the piezoelectric material include lead zirconate titanate (PZT), lithium niobate, barium titanate, lead titanate, and lead metaniobate.

The second substrate 112 is provided with a common circulation channel 112a with which all of the plurality of individual circulation channels 111a communicate at the most downstream portion thereof. The common circulation channel 112a is a groove extending along the longitudinal direction of the head 55 on the back surface of the second substrate 112. The most downstream portion of the common circulation channel 112a communicates with the vertical circulation channel 112b provided to the second substrate 112. The vertical circulation channel 112b communicates with the outlet 103c to enable circulation of the ink.

The third substrate 113 is provided with a manifold 56 which extends along the longitudinal direction of the head 55 and with which all of the plurality of individual supply channels 57 communicate at the most upstream portion. The manifold 56 is a groove provided on the back surface side of the third substrate 113. The third substrate 113 may be, for example, a substrate made of resin such as polyimide or may be a substrate made of metal such as SUS.

Hereinafter, pressure loss resistance in the head 55 will be described. (1) Relationship of pressure loss resistance between the individual supply channel 57 and the individual circulation channel 111a, (2) Relationship of pressure loss resistance between the individual circulation channels 111a, and (3) Relationship of pressure loss resistance between the individual supply channels 57 will be described later. Since a known technique described in, for example, PTL 3 or the like can be applied to a detailed configuration in the head 55 which does not affect these relationships, a detailed description thereof will be omitted herein.

### [Pressure Loss Resistance in Channel and Adjustment of Pressure Loss]

A pressure loss ΔP in a channel such as an individual supply channel 57 or an individual circulation channel 111a can be calculated by the following equation.

$$Δ P = λ \times \frac{l}{d} \times \frac{ρ \times {u}^{2}}{2} \\ λ = \frac{64}{Re} \\ Re = \frac{ρ \times u \times d}{μ} ,$$

where λ represents a pipe friction coefficient, l represents the length of a pipe, d represents the diameter of the pipe, p represents a fluid density, u represents an average flow velocity, and Re represents a Reynolds number. However, in the case of a pipe other than a circular pipe, the following hydraulic diameter (equivalent diameter) dₑ is used as the pipe diameter.

$${d}_{e} = 4 \times \frac{A}{L} ,$$

where A represents the cross-sectional area of the pipeline, and L represents a wetted perimeter (wall length in the cross-section).

### (Equation 1)

In the case of a pipeline whose shape changes by bending, width change, or the like, a shape loss coefficient ξ is used instead of the pipe friction coefficient (λ×l/d). The shape loss coefficient ξ increases as the bending angle increases in the case of bending and increases as the difference between the cross-sectional areas before and after the shape change increases in the case of the shape change. When the channel to be considered is constituted by a plurality of channel portions having different shapes, an estimated value of the pressure loss of the entire channel to be considered can be calculated by adding the pressure losses of the respective channel portions.

The “pipe” in the equation refers to the individual supply channel 57 or the individual circulation channel 111a. Further, the fluid refers to ink.

As is understood from this equation, the pressure loss of the ink is proportional to the length of the individual supply channel 57 (or the individual circulation channel 111a). Furthermore, the pressure loss of the ink is inversely proportional to the diameter of the individual supply channel 57 (or the individual circulation channel 111a). Thus, the pressure loss of the ink is inversely proportional to the cross-sectional area of the individual supply channel 57 (or the individual circulation channel 111a). In addition, in a case where the individual supply channel 57 (or the individual circulation channel 111a) has a shape other than a circular pipe, the pressure loss of the ink is inversely proportional to a hydraulic diameter determined according to a cross-sectional aspect ratio of the individual supply channel 57 (or the individual circulation channel 111a). Moreover, in a case where the individual supply channel 57 (or the individual circulation channel 111a) changes in shape, the pressure loss of the ink is proportional to the magnitude of the shape change.

Therefore, the resistance that causes the pressure loss of the ink (hereinafter referred to as “pressure loss resistance”) is determined on the basis of the length, diameter (cross-sectional area), cross-sectional aspect ratio, and magnitude of the shape change (e.g., bending angle) of the individual supply channel 57 (or the individual circulation channel 111a). Therefore, adjusting at least one of the length, diameter (cross-sectional area), cross-sectional aspect ratio, and/or magnitude of the shape change (e.g., bending angle) of the individual supply channel 57 or the individual circulation channel 111a enables easy adjustment of the pressure loss resistance, whereby a desired pressure loss can be obtained.

[(1) Relationship of Pressure Loss Resistance Between Individual Supply Channel 57 and Individual Circulation Channel 111a]

In the present embodiment, by setting the cross-sectional areas and the like of the individual supply channels 57 and the individual circulation channels 111a by the above-described method, the overall pressure loss resistance of the plurality of individual circulation channels 111a is made sufficiently less than the overall pressure loss resistance of the plurality of individual supply channels 57. For example, the cross-sectional areas of all the individual circulation channels 111a are set to be sufficiently smaller than the cross-sectional areas of all the individual supply channels 57. Accordingly, it is possible to suppress escape of the pressure generated in the nozzle section 59a to the channel on the discharge side or propagation of the pressure to another nozzle section 59a.

Here, the overall pressure loss resistance is, as an example, an average value of pressure loss resistances. To be specific, the overall pressure loss resistance of the plurality of individual supply channels 57 is a mean value of the pressure loss resistances of all the individual supply channels 57-1 to 57-6, and the overall pressure loss resistance of the plurality of individual circulation channels 111a is a mean value of the pressure loss resistances of all the individual circulation channels 111a. It is preferred that the overall pressure loss resistance of the plurality of individual circulation channels 111a is set to be equal to or greater than twice the overall pressure loss resistance of the plurality of individual supply channels 57, in that a significant difference can be generated between the two pressure losses.

[(2) Relationship of Pressure Loss Resistance Between Individual Circulation Channels 111a]

In the present embodiment, by setting the cross-sectional area and the like of each of the individual circulation channels 111a by the above-described method, the pressure loss resistances of the individual circulation channels 111a are made uniform. Here, for example, if the ratio of the maximum value to the minimum value (maximum value/minimum value) among the pressure loss resistances of the plurality of individual circulation channels 111a is a predetermined value (e.g., 1.1) or less, it may be considered that the pressure loss resistances are uniform among the plurality of individual circulation channels 111a. For example, when the lengths, the diameters (cross-sectional areas), the cross-sectional aspect ratios, and the magnitude of the shape change (for example, bending angles) of all the individual circulation channels 111a are set to be the same, the pressure loss resistances of the individual circulation channels 111a can be made uniform. For example, when there is a difference in the length, another factor such as a cross-sectional area can be made to be different.

### [(3) Relationship of Pressure Loss Resistance Between Individual Supply Channels 57]

In the present embodiment, the pressure loss resistances of the individual supply channels 57 are made non-uniform by setting the cross-sectional areas and the like of the individual supply channels 57 by the above-described method. Here, for example, if the pressure loss resistances of at least two individual supply channels 57 among the plurality of individual supply channels 57 are different from each other, it may be considered that the pressure loss resistances are uneven among the individual supply channels 57. However, it is desirable that the pressures of the plurality of nozzle sections 59a are made uniform (the difference between the pressures of the plurality of nozzle sections 59a is less than a predetermined value) by making the pressure loss resistances of the individual supply channels 57 non-uniform.

For example, as illustrated in FIG. 5B, the cross-sectional areas of the individual supply channels 57 are increased (S1<S2<S3<S4<S5<S6), for example, by increasing the diameter of the individual supply channel 57 as the individual supply channel 57 is separated farther from the inlet of the manifold 56. With this configuration, the pressure loss resistance of the individual supply channel 57 communicating with the manifold 56 at a position relatively far from the inlet of the manifold 56 is less than the pressure loss resistance of the individual supply channel 57 communicating with the manifold 56 at a position relatively close to the inlet of the manifold 56. Thus, the pressures of the plurality of nozzle sections 59a can be made uniform.

As described above, according to the present embodiment, the inkjet head 55 includes: a plurality of individual supply channels 57 that individually supply ink from the manifold 56 to a plurality of nozzle sections 59a; and a plurality of individual circulation channels 111a that individually discharge the ink from the plurality of nozzle sections 59a to a common circulation channel 112a. The overall pressure loss resistance of the plurality of individual circulation channels 111a is greater than the overall pressure loss resistance of the plurality of individual supply channels 57, the pressure loss resistances of the plurality of individual circulation channel 111a are made uniform, and the pressure loss resistances of the plurality of individual supply channels 57 are made non-uniform so that the pressures of the plurality of nozzle sections 59a are made uniform. Thus, the ejection stability of the nozzle section 59a can be more surely secured.

In addition, in the present embodiment, the inkjet printer 1 includes the drawing section 50 which includes the inkjet head 55, supplies the ink to the plurality of nozzle sections 111a by the manifold 56 and the plurality of individual supply channels 57 while circulating the ink by the plurality of individual circulation channels 112a and the common circulation channel 59a, and performs drawing by ejecting the ink from the plurality of nozzle sections 59a. As a result, it is possible to perform drawing on the recording medium M while realizing the above-described effects which can be achieved by the above-described configuration of the inkjet head 55.

Incidentally, in recent years, various functionalities have been required for an ink used in an inkjet recording apparatus, and as a result, the ink has become highly viscous or contains particles. In particular, when particles having a large particle size are contained, a polymer component is often further contained for particle dispersion in the ink, and as a result, the viscosity tends to be high. For example, when an ink to be used contains particles having a particle diameter of 0.5 μm or greater at D90, the ink exhibits remarkably high viscosity. Note that the particle diameter is defined as a volume-based mean diameter. In addition, the particle diameter measurement method is not particularly limited, but the particle diameter can be measured by an apparatus using a dynamic light scattering method or a laser diffraction method. For example, Zetasizer series utilizing a dynamic light scattering method manufactured by Malvern Panalytical Co., Ltd. or Mastersizer series utilizing a laser diffraction method manufactured by the same company can be suitably used.

The above-described high-viscosity ink has a viscosity of, for example, 25 mPa·s or more. On the other hand, in the conventional inkjet recording apparatus, the viscosity of the ejectable ink is limited, and in general, the viscosity of the ejectable ink is 15 to 20 mPa·s. Therefore, in recent years, there has been a demand for an inkjet head and an inkjet recording apparatus that can stably eject even high-viscosity ink.

In this regard, in the inkjet head 55 according to the present embodiment, in particular, the pressure loss resistances of the plurality of individual supply channels 57 are made non-uniform so that the pressures in the plurality of nozzle sections 59a during non-ejection are uniform, thereby achieving a configuration in which a pressure difference (pressure distribution) among the nozzle sections 59a is unlikely to remain during non-ejection. Therefore, the possibility of causing ejection failure such as ink overflow or air bubble entrainment in the nozzle section 59a due to a pressure difference (pressure distribution) in the nozzle section 59a is suppressed. Therefore, the inkjet head 55 according to the present embodiment and the inkjet printer 1 including the inkjet head 55 can secure ejection stability of the nozzle sections even when a high-viscosity ink is used. Note that the pressure distributions of the plurality of nozzle sections 59a during non-ejection falls within the range from −0.05 kPa to −1.0 kPa.

### [Variation 1]

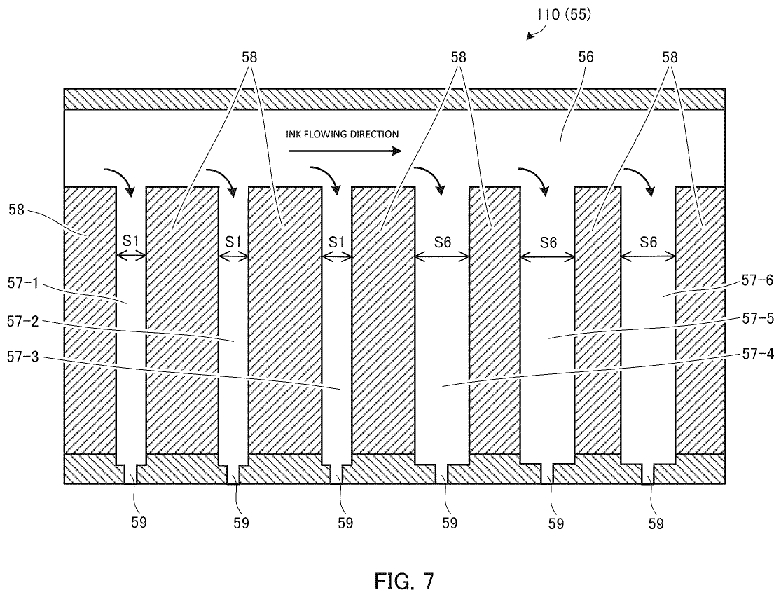

FIG. 7 is a diagram schematically illustrating a configuration of a main part of a cross section along the longitudinal direction of the head chip 110 in the inkjet head 55 according to Variation 1 of the present embodiment.

In the present variation, the pressure loss resistances of the plurality of individual supply channels 57 are made non-uniform, using a unit consisting of one or more individual supply channels. More particularly, in the present variation, the downstream group consisting of the individual supply channels 57-4, 57-5, and 57-6 that communicate with the manifold 56 on the downstream side is formed to have a larger cross-sectional area than the upstream group consisting of the individual supply channels 57-1, 57-2, and 57-3 that communicate with the manifold 56 on the upstream side (S6>S1), thereby reducing the overall pressure loss resistance (average value) of the downstream group compared to the overall pressure loss resistance (average value) of the upstream group. The same effect as that of the present embodiment can be realized in this case. Furthermore, since the structure of the present variation is slightly simpler than the structure of the present embodiment, dimension management at the time of manufacturing is easy, and there is also an effect that manufacturing cost and manufacturing variation can be suppressed.

### [Variation 2]

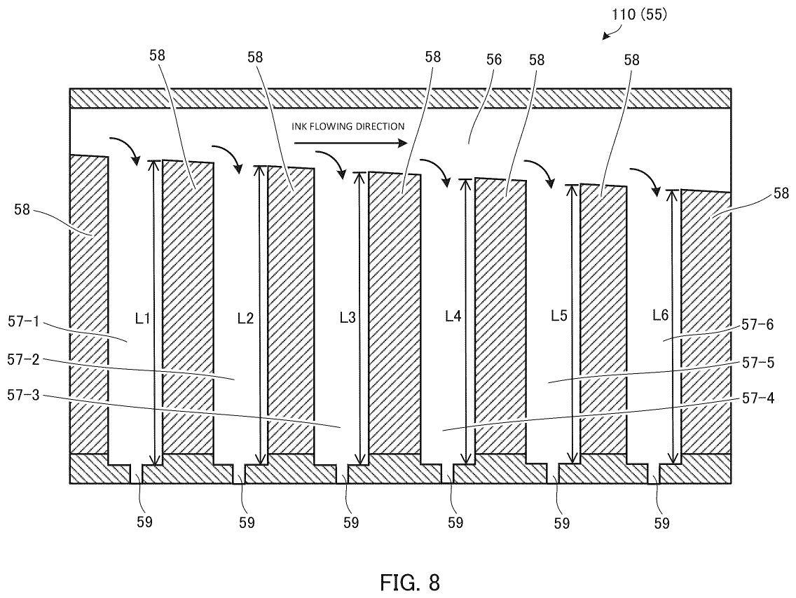

FIG. 8 is a diagram schematically illustrating a configuration of a main part of a cross section along the longitudinal direction of the head chip 110 in the inkjet head 55 according to Variation 2 of the present embodiment.

In the present variation, the lengths of the plurality of individual supply channels 57 are made different from one another, whereby the pressure loss resistances of the plurality of individual supply channels 57 are made non-uniform. To be more specific, in the present variation, the lengths of the individual supply channels 57 communicating with the manifold 56 at positions farther from the inlet of the manifold 56 are set to be shorter (L1>L2>L3>L4>L5>L6). As a result, the pressure loss resistance of the individual supply channel 57 located further downstream becomes lower. The same effect as that of the present embodiment can be realized also in this case. Furthermore, in the structure of the present variation, it is sufficient that the upper surface portion of the second substrate 112 where the manifold 56 is formed is formed as an inclined surface, and therefore, the manufacturing is easy, and there is also an effect that the manufacturing cost and the manufacturing variation can be suppressed.

### [Variation 3]

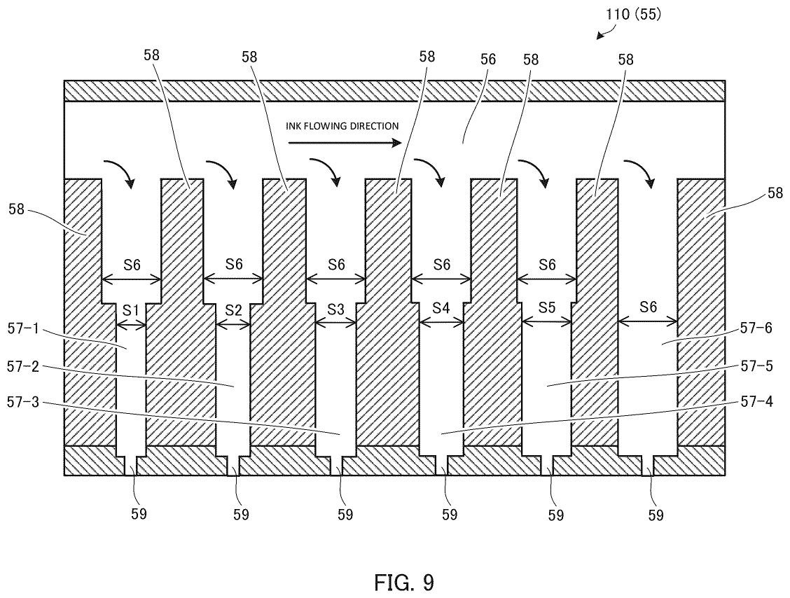

FIG. 9 is a diagram schematically illustrating a configuration of a main part of a cross section along the longitudinal direction of the head chip 110 in the inkjet head 55 according to Variation 3 of the present embodiment.

In the present variation, a throttle portion (step) is provided in an intermediate portion of each of the plurality of individual supply channels 57, and the degree of reduction in the cross-sectional area by the throttle portion is made different, whereby the pressure loss resistance of each of the plurality of individual supply channels 57 is made non-uniform. To be more specific, in the present variation, the degree of reduction in the cross-sectional area of the individual supply channel 57 communicating with the manifold 56 at a position farther away from the inlet of the manifold 56 by the throttle portion is set to be greater ((S1/S6)<(S2/S6)<(S3/S6)<(S4/S6)<(S5/S6)<(S6/S6)). As a result, the pressure loss resistance of the individual supply channel 57 located further downstream becomes lower. The same effect as that of the present embodiment can be realized also in this case.

### [Variation 4]

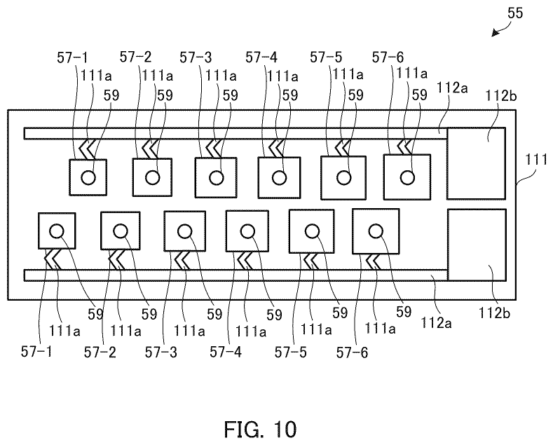

FIG. 10 is a diagram schematically illustrating a planar configuration around nozzles in the inkjet head 55 according to Variation 4 of the present embodiment.

In the present variation, the individual circulation channel 111a has, for example, a V-shaped bending portion. Since the individual circulation channel 111a has the bending portion, a certain pressure loss resistance can be secured even if the individual circulation channel 111a has a small size. However, to equalize the pressure loss resistances of the individual circulation channels 111a, the bending angles of the bending portions are equalized.

Although the embodiment of the present invention has been specifically described above, the present invention is not limited to the above-described specific embodiment. Various modifications and changes can be made to the specific example described in the above embodiment within the scope of the spirit of the present invention described in the claims.

The disclosures of Japanese Patent Application No. 2023-039518, filed on Mar. 14, 2023, including the specification, drawings and abstract, is incorporated herein by reference in its entirety.

### INDUSTRIAL APPLICABILITY

The present invention is useful as an inkjet head and an inkjet recording apparatus that can improve ejection stability of a nozzle section.

### REFERENCE SIGNS LIST

1 Inkjet printer
10 Conveyance section
11 Conveyance belt
11a Conveyance surface
12 Drive roller
13 Driven roller
20 Supply section
21 Supply stacking section
22 Supply conveyance section
30 Ejection section
31 Ejection stacking section
32 Ejection conveyance section
40 Ink supply section
41 Main tank
42 Channel
50 Drawing section
51 Carriage
52a First sub-tank
52b Second sub-tank
53a, 53b, 53c Channel
54 Head driver
55 Inkjet head
56 Manifold (Common supply channel)
57 Individual supply channel
58 Piezoelectric element
59 Nozzle
59a Nozzle section
60 Reading section
70 Operation and display part
80 Input/output interface
90 Controller
91 CPU
92 RAM
93 ROM
94 Storage section
95 Heating section
99 External device
101 Housing
102 Exterior component
103a Inlet
103b, 103c Outlet
104 Attachment hole
110 Head chip
111 First substrate
111a Individual circulation channel
112 Second substrate
112a Common circulation channel
112b Vertical circulation channel
113 Third substrate

1. A inkjet head, comprising:
a plurality of individual supply channels that individually supply ink from a common supply channel to a plurality of nozzles; and
a plurality of individual circulation channels that individually discharge the ink from the plurality of nozzles to a common circulation channel, wherein
pressure loss resistances of the plurality of individual circulation channels having greater overall pressure loss resistance than the plurality of individual supply channels are made uniform, and pressure loss resistances of the plurality of individual supply channels are made non-uniform so that pressures of the plurality of nozzles are made uniform.

2. The inkjet head according to claim 1, wherein
the overall pressure loss resistance is a mean value of pressure loss resistances, and
the mean value of the pressure resistances of the plurality of individual circulation channels is equal to or greater than twice the mean value of the pressure loss resistances of the plurality of individual supply channels.

3. The inkjet head according to claim 1, wherein
one of the plurality of individual supply channels that communicates with the common supply channel at a position relatively far from an inlet of the common supply channel has a lower pressure loss resistance than another of the plurality of individual supply channels that communicates with the common supply channel at a position relatively close to the inlet of the common supply channel.

4. The inkjet head according to claim 1, wherein
the pressure loss resistances of the plurality of individual supply channels are made non-uniform, using a unit of a group including at least one individual supply channel.

5. The inkjet head according to claim 4, wherein
the plurality of individual supply channels includes an upstream group including at least one individual supply channel communicating with the common supply channel on an upstream side and a downstream group including at least one individual supply channel communicating with the common supply channel on a downstream side, and overall pressure loss resistance of the downstream group is reduced relative to overall pressure loss resistance of the upstream group.

6. The inkjet head according to claim 1, wherein
the pressure loss resistances of the plurality of individual supply channels are made non-uniform by varying at least one of a length, a cross-sectional area, a bending angle, and/or a cross-sectional aspect ratio between one individual supply channel and another individual supply channel.

7. The inkjet head according to claim 1, wherein
the pressure loss resistances of the plurality of individual supply channels are made non-uniform by varying at least one of a diameter of a throttle, a length of the throttle, and/or a number of the throttles between one individual supply channel and another individual supply channel.

8. The inkjet head according to claim 1, wherein
the plurality of individual circulation channels each have a bending portion.

9. The inkjet head according to claim 8, wherein
a bending angle of the bending portion is uniform.

10. The inkjet head according to claim 1, wherein
pressure distributions of the plurality of nozzles during non-ejection fall within a range from −0.05 kPa to −1.0 kPa by non-uniformity of the pressure loss resistances of the plurality of individual supply channels.

11. The inkjet head according to claim 1, wherein
pressures of the plurality of nozzles during non-ejection are made uniform by non-uniformity of the pressure loss resistances of the plurality of individual supply channels, when an ink having a viscosity equal to or higher than 25 mPa·s is used.

12. The inkjet head according to claim 11, wherein
the ink to be used contains particles having a particle diameter equal to or greater than 0.5 μm at D90.

13. The inkjet head according to claim 1, wherein
the inkjet head is a shear-mode inkjet head.

14. An inkjet recording apparatus comprising a drawer that includes the inkjet head according to claim 1, supplies ink to the plurality of nozzles through the common supply channel and the plurality of individual supply channels while circulating the ink through the plurality of individual circulation channels and the common circulation channel, and ejects the ink from the plurality of nozzles to perform drawing.
